(19) United States
(12) Patent Application Publication
(10) Pub. No.: US 2011/0234338 A1
(43) Pub. Date: Sep. 29, 2011

(54) Bundled leaky transmission line, communication device, and communication system

(75) Inventor: Hiroaki Takahashi, Kanagawa (JP)

(73) Assignee: Sony Corporation, Tokyo (JP)

(21) Appl. No.: 12/932,594

(22) Filed: Mar. 1, 2011

(30) Foreign Application Priority Data
Mar. 23, 2010 (JP) P2010-066632

(51) Int. Cl. H01Q 13/22; H01P 3/00

(52) U.S. Cl. 333/237; 343/770

(57) ABSTRACT

A bundled leaky transmission line includes a transmission line inside which a signal is transmitted, wherein multiple leaky transmission lines which exchange a radio wave mainly via a slit provided on an outer circumference of the transmission line are bundled, and the leaky transmission lines are bundled together such that the slit which is provided to each of the leaky transmission lines and which gives radio wave directionality to the leaky transmission line is directed in a direction different from each other.

### BACKGROUND OF THE INVENTION

1. Field of the Invention

The present invention relates to a bundled leaky transmission line, a communication device, and a communication system, and particularly relates to a bundled leaky transmission line, a communication device, and a communication system which can facilitate appropriate installation of multiple leaky transmission lines used as a MIMO antenna.

2. Description of the Related Art

Along with the spread of wireless local area networks (LANs) in recent years, there have been increasing demands to not only perform communication through a wireless area set with respect to a relatively small area such as a standard home but also perform communication through a wireless area set with respect to a broad range such as an office or a public facility.

Measures to cover such a broad range with one access point generally include a method of increasing radio output of an access point or a terminal which performs communication with an access point and a method of providing a high-gain antenna as a built-in antenna.

However, increasing radio output may increase power consumption, thus quickening battery consumption of a mobile terminal, for example. Also, due to large size, a high-gain antenna has been unsuitable for a mobile terminal, for which small-sizing is an assumption.

Therefore, a method of covering a broad planar area by using a leaky coaxial cable for an antenna on the access point side without changing the equipment on the mobile terminal side has been devised (for example, see Japanese Unexamined Patent Application Publication No. 2004-135159).

Further, in recent years, a multiple-input multiple-output (MIMO) communication system using multiple antennas has become increasingly mainstream along with the advance of wireless technology. This technique is a system of multiplexing and transmitting different transmission streams utilizing the difference in radio wave paths from the respective multiple antennas, i.e., the fact that, mathematically, correlation is low.

Herein, a case of applying a leaky coaxial cable to a MIMO antenna will be described. FIG. 1 is a sectional view illustrating a room for which three leaky coaxial cables are installed as a MIMO antenna. In FIG. 1, sectional surfaces of the leaky coaxial cables are shown. In an example of FIG. 1, the three leaky coaxial cables are located together near a ceiling.

These leaky coaxial cables are of normal omnidirectional type. In this case, a radio wave between a terminal and the leaky coaxial cable is dominantly a direct wave. As described above, the leaky coaxial cables are located to be in proximity to each other. Thus, since there is not a great difference in positional relation of the terminal and each of the three antennas, correlation between the antennas (between the leaky coaxial cables) is high, thereby possibly preventing the characteristic of MIMO from being obtained sufficiently. Generally, in the case of MIMO, an interval of λ/2 or greater between antennas is advisable.

Thus, a method of locating the three leaky coaxial cables sufficiently apart from each other, as in FIG. 2, is conceivable. In this case, the characteristic of MIMO can be ensured sufficiently since there is a high possibility that distances from the respective leaky coaxial cables to the terminal differ greatly.

### SUMMARY OF THE INVENTION

However, in general, there are many limitations to the location of a leaky coaxial cable, and it has been difficult to arrange multiple leaky coaxial cables in arbitrary positions. For example, a leaky coaxial cable can often only be located in a limited place such as a cable rack. That is, depending on the space, it may have been difficult to arrange multiple leaky coaxial cables with sufficient distance from each other beyond the capacity of one cable rack, as shown in FIG. 2.

Also, preparing a new cable rack in order to locate the leaky coaxial cables sufficiently apart from each other not only leads to an increase in installation cost but also poses a risk of impairing the appearance of the space.

Further, for usage in MIMO (to sufficiently ensure the characteristic of MIMO), it is preferable to lower the correlation between branches (antennas) by setting the distance between antennas (between leaky coaxial cables) to λ/2 or greater or causing polarized radio waves emitted from an antenna (leaky coaxial cable) to be orthogonal.

However, this is possible only if an installer installing a coaxial cable is highly knowledgeable of antennas. Therefore, when a leaky coaxial cable is installed in a space where the technical difficulty of installation is high or a leaky coaxial cable is installed by a person with poor knowledge regarding antennas, there has been a risk of impairing the characteristic of MIMO.

Thus, it is desirable to provide a leaky coaxial cable which sufficiently ensures the characteristic of MIMO and for which there are sufficient degree of freedom and easiness in installation.

An embodiment of the present invention provides a bundled leaky transmission line including a transmission line inside which a signal is transmitted, wherein multiple leaky transmission lines which exchange a radio wave mainly via a slit provided on an outer circumference of the transmission line are bundled, and the leaky transmission lines are bundled together such that the slit which is provided to each of the leaky transmission lines and which gives radio wave directionality to the leaky transmission line is directed in a direction different from each other.

The leaky transmission lines may be bundled together with a predetermined supporting material so as to maintain a distance of half a wavelength of the exchanged radio wave or greater.

The slit of each of the leaky transmission lines may be provided at an angle different from each other so that a radio wave of which a direction of a polarization plane is different from each other is exchanged.

The leaky transmission line may be a leaky coaxial cable which includes a center conductor as the transmission line and an external conductor formed on an outer circumference of the center conductor with an insulator in between and including the slit.

The leaky transmission line may be a leaky waveguide which includes, as the transmission line, a tubular conductor provided with the slit and having a hollow structure.

Each of the leaky transmission lines may function as a multiple-input multiple-output (MIMO) antenna which simultaneously exchanges a signal different from each other.

A communication device according to another embodiment of the present invention includes a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna, and communication means for exchanging a signal via the bundled leaky transmission line to perform MIMO communication with another device.

In a communication system according to still another embodiment of the present invention in which a first communication device and a second communication device perform communication with each other, the first communication device includes a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna, and first communication means for exchanging a signal via the bundled leaky transmission line to perform MIMO communication with the second communication device, and the second communication device includes second communication means for performing the MIMO communication with the first communication device.

According to the embodiment of the present invention, the transmission line inside which a signal is transmitted is included, the multiple leaky transmission lines which exchange a radio wave mainly via the slit provided on the outer circumference of the transmission line are bundled, and the leaky transmission lines are bundled together such that the slit which is provided to each of the leaky transmission lines and which gives radio wave directionality to the leaky transmission line is directed in a direction different from each other.

According to the other embodiment of the present invention, the bundled leaky transmission line and the communication means are included. The bundled leaky transmission line includes the transmission line inside which a signal is transmitted, wherein the multiple leaky transmission lines which exchange a radio wave mainly via the slit provided on the outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna. The communication means exchanges a signal via the bundled leaky transmission line to perform MIMO communication with another device.

According to the still other embodiment of the present invention, the first communication device in the communication system in which the first communication device and the second communication device perform communication with each other includes the bundled leaky transmission line including the transmission line inside which a signal is transmitted, wherein the multiple leaky transmission lines which exchange a radio wave mainly via the slit provided on the outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna, and the first communication means for exchanging a signal via the bundled leaky transmission line to perform MIMO communication with the second communication device, and the second communication device includes the second communication means for performing the MIMO communication with the first communication device.

According to the embodiments of the present invention, communication can be performed. Particularly, appropriate installation of multiple leaky transmission lines used as a MIMO antenna can be facilitated.

### BRIEF DESCRIPTION OF THE DRAWINGS

FIG. 1 illustrates an installation example of a leaky coaxial cable of the related art;

FIG. 2 illustrates another installation example of a leaky coaxial cable of the related art;

FIG. 3 illustrates a main configuration example of a bundled leaky coaxial cable according to an embodiment of the present invention;

FIG. 4 illustrates the directionality of the bundled leaky coaxial cable in FIG. 3;

FIG. 5 illustrates an example of dominant radio wave paths;

FIG. 6 illustrates another configuration example of the bundled leaky coaxial cable according to the embodiment of the present invention;

FIG. 7 illustrates still another configuration example of the bundled leaky coaxial cable according to the embodiment of the present invention;

FIG. 8 illustrates yet another configuration example of the bundled leaky coaxial cable according to the embodiment of the present invention;

FIGS. 9A and 9B illustrate a configuration example of a bundled leaky waveguide according to another embodiment of the present invention;

FIG. 10 illustrates a configuration example of a communication system according to still another embodiment of the present invention; and

FIG. 11 illustrates a configuration example inside a base station.

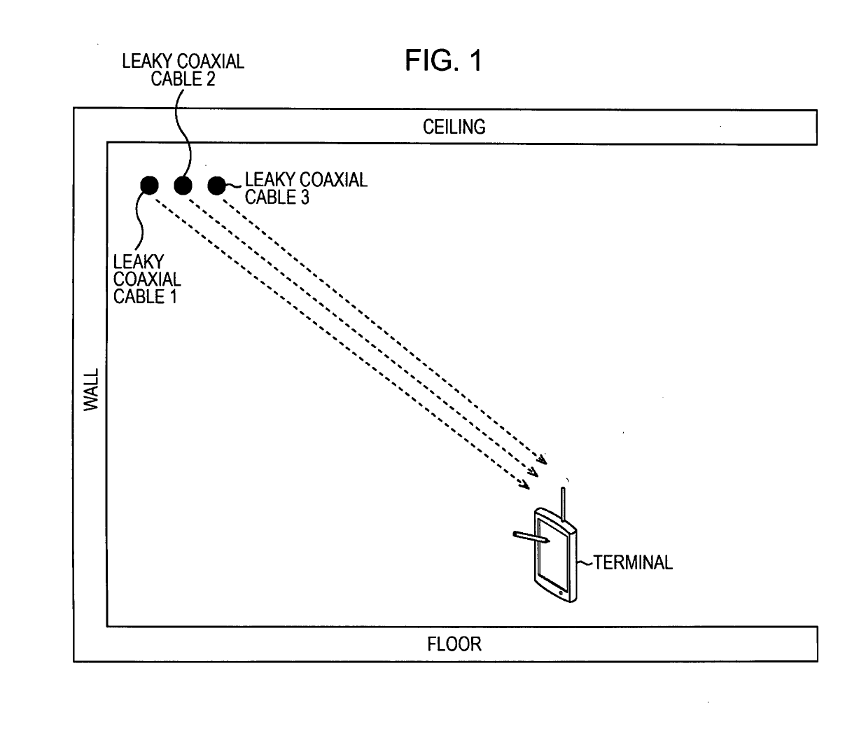

### DESCRIPTION OF THE PREFERRED EMBODIMENTS

Modes for carrying out the present invention (referred to below as embodiments) will be described below in the following order.

1. Embodiment (bundled leaky coaxial cable)

2. Another embodiment (leaky waveguide)

3. Still another embodiment (communication system)

### 1. Embodiment

### Configuration of a Bundled Leaky Coaxial Cable

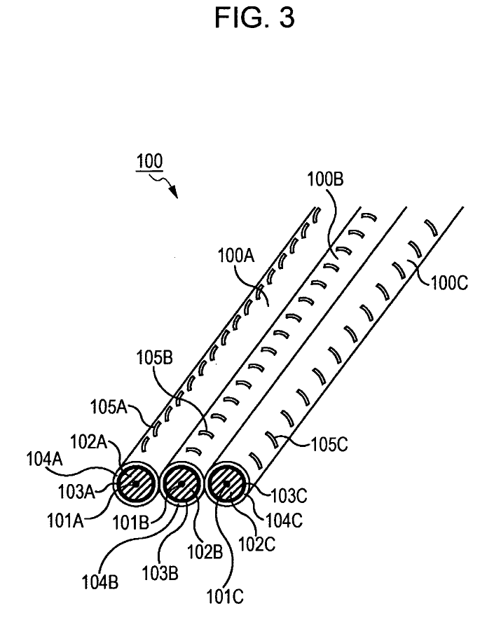

FIG. 3 illustrates a main configuration example of a bundled leaky coaxial cable according to an embodiment of the present invention.

A bundled leaky coaxial cable 100 shown in FIG. 3 is bound (bundled) in a state where an appropriate number of leaky coaxial cables are held together and is used as a multiple-input multiple-output (MIMO) antenna.

The MIMO refers to a wireless communication technique in which multiple antennas are combined to increase the bandwidth for data exchange. For example, applications include a high-speed wireless local area network (LAN).

In a normal wireless LAN communication, there has been a limit to the bandwidth such as, for example, 54 Mbps. However, in MIMO, different pieces of data are sent simultaneously with multiple antennas and synthesized at the time of reception to apparently increase the bandwidth for a high-speed communication. Theoretically, the apparent bandwidth increases in proportion to the number of used antennas.

Also, in the case of MIMO, there is an effect of significantly improving the communication situation through a stable exchange of radio waves reaching through multiple paths from multiple antennas in an environment where many obstacles exist.

Note that the number of leaky coaxial cables to be bundled is arbitrary. Described below is an example in which the number is three.

In the bundled leaky coaxial cable 100, a leaky coaxial cable 100A, a leaky coaxial cable 100B, and a leaky coaxial cable 100C are bundled together along the longitudinal direction of the cable. Note that the thickness of the leaky coaxial cable 100A, the leaky coaxial cable 100B, and the leaky coaxial cable 100C is arbitrary.

The leaky coaxial cable is a coaxial cable for, via a slit opened at a predetermined interval, intentionally radiating a signal transmitted through an internal transmission line as an external radio wave or receiving an external radio wave to be transmitted through an internal transmission line as a received signal.

FIG. 3 shows a sectional surface thereof. For example, the leaky coaxial cable 100A is formed with a center conductor 101A, an insulator 102A, an external conductor 103A, and an external film 104A from the center toward the outside.

The center conductor 101A is a wire formed of a conductor such as, for example, copper, silver, gold, or aluminum. The insulator 102A is formed to cover the center conductor 101A over the entire length. The insulator 102A is configured of an insulating material having stable insulating properties and formability such as, for example, polyethylene or fluorine resin.

The external conductor 103A is formed to cover the insulator 102A over the entire length. The external film 104A is formed to cover the external conductor 103A over the entire length.

Note that the external conductor 103A is provided with multiple slits 105A (small holes) of a predetermined size at a predetermined interval. The slit 105A is shown to be on the external film 104A in FIG. 3, but is actually provided to the external conductor 103A. Note that the slit 105A may penetrate up to the external film 104A. The thickness, the width, or the size of the center conductor 101A, the insulator 102A, the external conductor 103A, the external film 104A, and the slit 105A is arbitrary.

Although one of the multiple slits provided to the leaky coaxial cable 100A is shown as the slit 105A in FIG. 3, the slit 105A basically refers to any one of the multiple slits provided to the leaky coaxial cable 100A in the description below. Note that an arbitrary part (one or multiple slits) of the multiple slits provided to the leaky coaxial cable 100A may also, be referred to as the slit 105A.

The leaky coaxial cable 100B and the leaky coaxial cable 100C also have configurations similar to the leaky coaxial cable 100A. That is, the leaky coaxial cable 100B includes a center conductor 101B, an insulator 102B, an external conductor 103B, and an external film 104B. Also, the leaky coaxial cable 100C includes a center conductor 101C, an insulator 1020, an external conductor 103C, and an external film 104C.

In the bundled leaky coaxial cable 100, the leaky coaxial cable 100A, the leaky coaxial cable 100B, and the leaky coaxial cable 100C are bundled together by the external film 104A, the external film 104B, and the external film 104C being bound together (integrally formed) along the longitudinal direction thereof.

In a similar manner to the case of the external conductor 103A, the external conductor 103B and the external conductor 103C are also formed with a slit (slit 105B and slit 105C) of a predetermined size at a predetermined interval in a predetermined direction on the outer circumference.

The leaky coaxial cable 100A, the leaky coaxial cable 100B, and the leaky coaxial cable 100C respectively function as antennas to exchange radio waves, whereby the bundled leaky coaxial cable 100 functions as a MIMO antenna. That is, the bundled leaky coaxial cable 100 provides an apparent broadband communication through the leaky coaxial cable 100A, the leaky coaxial cable 100B, and the leaky coaxial cable 100C respectively exchanging data different from each other simultaneously.

The leaky coaxial cable 100A externally radiates (leaks) a signal transmitted through the center conductor 101A as a radio wave. Many of the signals are leaked from the slit 105A. Also, the leaky coaxial cable 100A receives a radio wave outside the cable and transmits the received signal through the center conductor 101A as an electrical signal. Many of the radio waves are received via the slit 105A.

As shown in FIG. 3, the slit 105A is formed as a part of the outer circumference of the external conductor 103A. That is, each slit 105A is formed in a predetermined direction on the outer circumference of the leaky coaxial cable 100A. The slit 105A gives radio wave directionality to the leaky coaxial cable 100A in the predetermined direction (direction of the slit 105A).

This is the same as in the leaky coaxial cable 100B and the leaky coaxial cable 1000. The slit 105B is formed in the predetermined direction on the outer circumference of the leaky coaxial cable 100B. The slit 105C is formed in the predetermined direction on the outer circumference of the leaky coaxial cable 100C. That is, the leaky coaxial cable 100B and the leaky coaxial cable 100C are also respectively given radio wave directionality in a predetermined direction.

In the bundled leaky coaxial cable 100, the slit 105A, the slit 105B, and the slit 105C are each formed to be directed in a direction different from each other. That is, the leaky coaxial cable 100A, the leaky coaxial cable 100B, and the leaky coaxial cable 100C are given radio wave directionality in a direction different from each other.

### [Directionality]

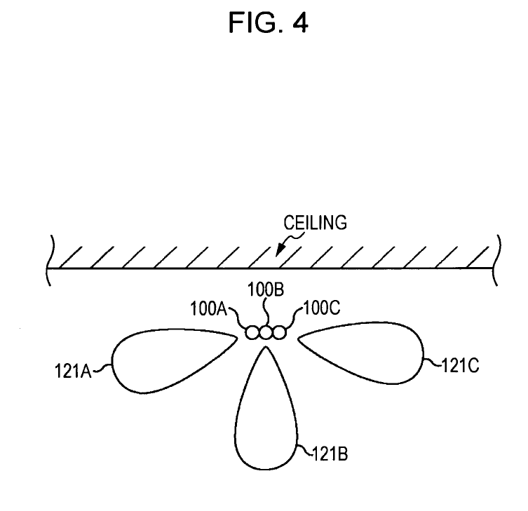

FIG. 4 illustrates the directionality of the bundled leaky coaxial cable 100 in FIG. 3.

A radiation pattern 121A shown in FIG. 4 is an example of a radiation pattern of a radio wave leaking from the leaky coaxial cable 100A. A radiation pattern 121B shown in FIG. 4 is an example of a radiation pattern of a radio wave leaking from the leaky coaxial cable 100B. A radiation pattern 1210 shown in FIG. 4 is an example of a radiation pattern of a radio wave leaking from the leaky coaxial cable 100C.

In the example in FIG. 4, the leaky coaxial cable 100A, the leaky coaxial cable 100B, and the leaky coaxial cable 100C are aligned and located near a ceiling to be respectively approximately parallel to the ceiling.

The leaky coaxial cable 100A is formed with the slit 105A facing away (directed toward the left in the drawing) from the leaky coaxial cable 100B and the leaky coaxial cable 100C to be approximately parallel to the ceiling. The leaky coaxial cable 100B is formed with the slit 105B approximately perpendicular (directed downward in the drawing) to the ceiling. The leaky coaxial cable 100C is formed with the slit 105C facing away (directed toward the right in the drawing) from the leaky coaxial cable 100A and the leaky coaxial cable 100B to be approximately parallel to the ceiling.

Thus, the radiation pattern 121A extends to be approximately parallel to the ceiling, the radiation pattern 121B extends to be approximately perpendicular to the ceiling, and the radiation pattern 1210 extends to be approximately parallel to the ceiling in an opposite direction of the radiation pattern 121A.

Each radiation pattern shows the radio wave directionality of the leaky coaxial cable. That is, the leaky coaxial cable 100A, the leaky coaxial cable 100B, and the leaky coaxial cable 100C are each given radio wave directionality in a direction different from each other.

In this manner, in the bundled leaky coaxial cable 100, the multiple leaky coaxial cables are bundled and the slit of the predetermined size are provided to each leaky coaxial cable at the predetermined interval such that the direction of the leaky coaxial cable differs from each other. Thus, correlation between the respective leaky coaxial cables can be reduced. That is, the bundled leaky coaxial cable 100 can sufficiently ensure the characteristic of a MIMO antenna, which is to provide an apparent broadband communication to enable stable communication at high speed.

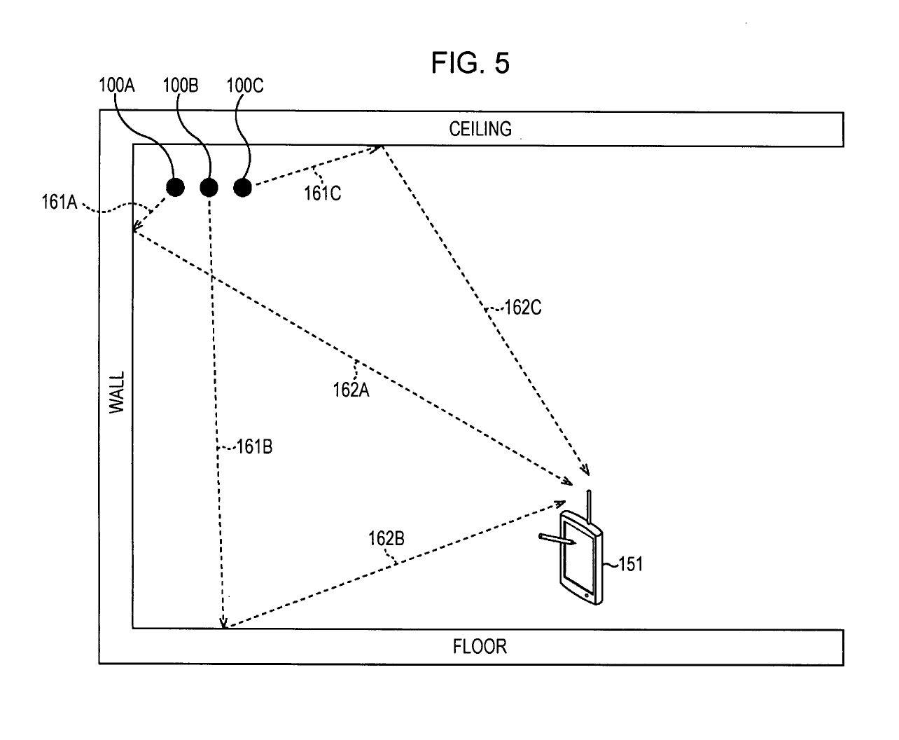

For example, as shown in FIG. 5, when exchange of radio waves (wireless communication) is performed between a terminal device 151 and the bundled leaky coaxial cable 100, a dominant propagation path (radio wave path) between the terminal device 151 and the bundled leaky coaxial cable 100 is significantly different for each leaky coaxial cable.

For example, for a radio wave directed from the leaky coaxial cable 100A toward the terminal device 151, a propagation path which reflects off a wall, such as that shown by an arrow 161A and an arrow 162A, is dominant. In contrast, for a radio wave directed from the leaky coaxial cable 100B toward the terminal device 151, a propagation path which reflects off a floor, such as that shown by an arrow 161B and an arrow 162B, is dominant. Further in contrast, for a radio wave directed from the leaky coaxial cable 100C toward the terminal device 151, a propagation path which reflects off a ceiling, such as that shown by an arrow 161C and an arrow 162C, is dominant.

That is, the correlation of the propagation paths decreases. Thus, improvement can be expected of the bundled leaky coaxial cable 100 in the characteristic (high speed and stability of communication) of a MIMO antenna.

Since the respective leaky coaxial cables are bundled in a state described above in the bundled leaky coaxial cable 100, the relation among the leaky coaxial cables is maintained regardless of who installs the bundled leaky coaxial cable 100. Thus, the bundled leaky coaxial cable 100 can be installed more easily compared to when the leaky coaxial cables are installed apart from each other. In other words, by using the bundled leaky coaxial cable 100, an installation worker can install the leaky coaxial cable to sufficiently obtain the characteristic of a MIMO antenna easily without expertise in antennas.

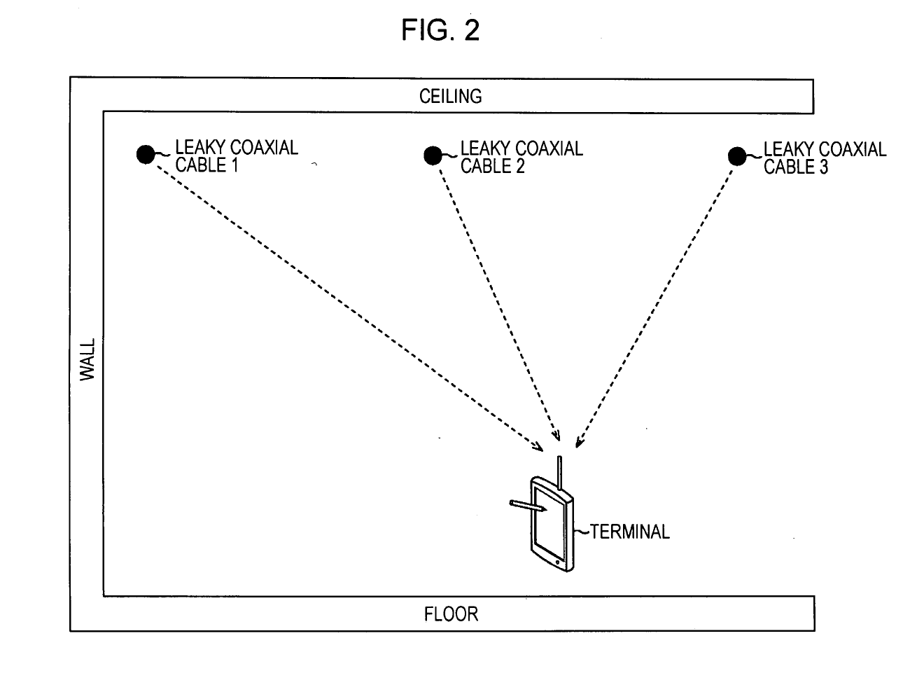

Also, since multiple leaky coaxial cables are bundled, the bundled leaky coaxial cable 100 can be installed in a limited installation space. That is, the leaky coaxial cables can be installed without spreading the range as in an example in FIG. 2, for example. Thus, by applying the bundled leaky coaxial cable 100 as a MIMO antenna, not only can the installation cost be reduced but also the appearance of the space can be prevented from being impaired by the installation of the antenna.

### [Configuration of the Bundled Leaky Coaxial Cable]

Note that a method of bundling the leaky coaxial cables is arbitrary. With FIG. 3, a case where the respective leaky coaxial cables are aligned and bundled linearly in a plane perpendicular to the longitudinal direction of the leaky coaxial cables has been described. However, this is not limiting, and the respective leaky coaxial cables may be aligned and bundled in a planar fashion in a plane perpendicular to the longitudinal direction of the leaky coaxial cables.

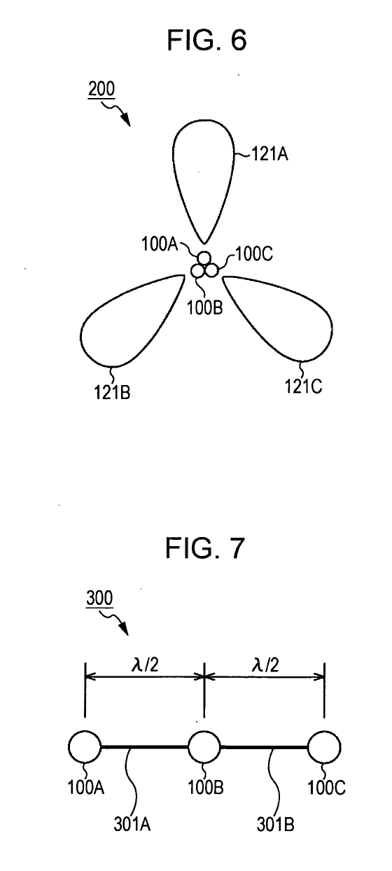

FIG. 6 illustrates another configuration example of the bundled leaky coaxial cable according to the embodiment of the present invention.

In a bundled leaky coaxial cable 200 shown in FIG. 6, the respective leaky coaxial cables are aligned and bundled in a triangle shape in a plane perpendicular to the longitudinal direction of the leaky coaxial cables. In each leaky coaxial cable, a slit is provided in a direction toward the nearest point of the triangle. Thus, the directions of radio wave radiation from the respective leaky coaxial cables differ from each other by 120 degrees.

Since the directions of the radio wave directionality of the respective leaky coaxial cables differ from each other also in this case, the correlation of propagation paths decreases and an improvement can be expected of the bundled leaky coaxial cable 200 in the characteristic of a MIMO antenna.

The easiness of installation and the amount of space for installation of the bundled leaky coaxial cable 200 are approximately similar to those of the bundled leaky coaxial cable 100. Note that, since the alignment of the respective leaky coaxial cables is different, the combination of the directions of the radio wave directionality differs from the case of the bundled leaky coaxial cable 100. Thus, the optimum location for installation may differ from the case of the bundled leaky coaxial cable 100.

For example, since the radio wave directionality is not directed in the upper direction in FIG. 4 in the case of the bundled leaky coaxial cable 100, the characteristic of a MIMO antenna can be sufficiently obtained easily even with installation close to a ceiling, a wall surface, or the like. However, since the radio wave directionality extends over the entire circumference of the bundled leaky coaxial cable 200 in the case of the bundled leaky coaxial cable 200, it is desirable the installation be at some distance from a ceiling, a wall surface, or the like.

### [Configuration of the Bundled Leaky Coaxial Cable]

In order to reduce the correlation between the leaky coaxial cables, the respective leaky coaxial cables may be bundled in a state distant from each other by half a wavelength λ (λ/2) or greater using a predetermined supporting material.

FIG. 7 illustrates still another configuration example of the bundled leaky coaxial cable according to the embodiment of the present invention.

As shown in FIG. 7, in the case of a bundled leaky coaxial cable 300, the leaky coaxial cable 100A and the leaky coaxial cable 100B are bundled with a supporting material 301A. In a similar manner, the leaky coaxial cable 100B and the leaky coaxial cable 100C are bundled with a supporting material 301B.

The supporting material 301A and the supporting material 301B are members for bundling multiple leaky coaxial cables while maintaining a predetermined distance. The supporting material 301A bundles the leaky coaxial cable 100A and the leaky coaxial cable 100B at a distance of λ/2. The supporting material 301B bundles the leaky coaxial cable 100B and the leaky coaxial cable 100C at a distance of λ/2.

By bundling the respective leaky coaxial cables while ensuring an interval of λ/2 or greater in this manner, the correlation between the leaky coaxial cables can be reduced. That is, improvement can be expected of the bundled leaky coaxial cable 300 in the characteristic of a MIMO antenna.

In the case of the bundled leaky coaxial cable 300, the radio wave directionality of each leaky coaxial cable is arbitrary. That is, the bundled leaky coaxial cable 300 can sufficiently ensure the characteristic of a MIMO antenna regardless of the direction of the slit of each leaky coaxial cable.

In other words, the degree of freedom in the radio wave directionality of each leaky coaxial cable increases. For example, the slit can be provided to each leaky coaxial cable in an arbitrary direction. Also, for example, the radio wave directionality of each leaky coaxial cable can be strengthened or weakened.

Note that, in a similar manner to the case of the bundled leaky coaxial cable 100 or the bundled leaky coaxial cable 200, providing the slit in a direction such that the radio wave directionality of each leaky coaxial cable is different from each another, the correlation between the leaky coaxial cables can further be reduced.

Note that the bundling pattern of the leaky coaxial cables with such a supporting material is arbitrary, as long as the distance between the respective leaky coaxial cables is λ/2 or greater. For example, three leaky coaxial cables may be bundled in a triangle shape by a supporting material with distances of λ/2 or greater, or four leaky coaxial cables may be bundled in a quadrangle shape by a supporting material with distances of λ/2 or greater.

### [Configuration of the Bundled Leaky Coaxial Cable]

Also, the configuration may be such that the leaky coaxial cables have different polarization planes as well as directional characteristics. For example, the polarizations of radio waves exchanged by the respective leaky coaxial cables may be a vertical polarization, a circular polarization, and a horizontal polarization so as to differ from each other. That is, by changing the angle of the slit, the polarization plane in which exchange is possible by the leaky coaxial cable changes. By changing the polarization plane for each leaky coaxial cable in this manner, the correlation between the leaky coaxial cables can further be reduced.

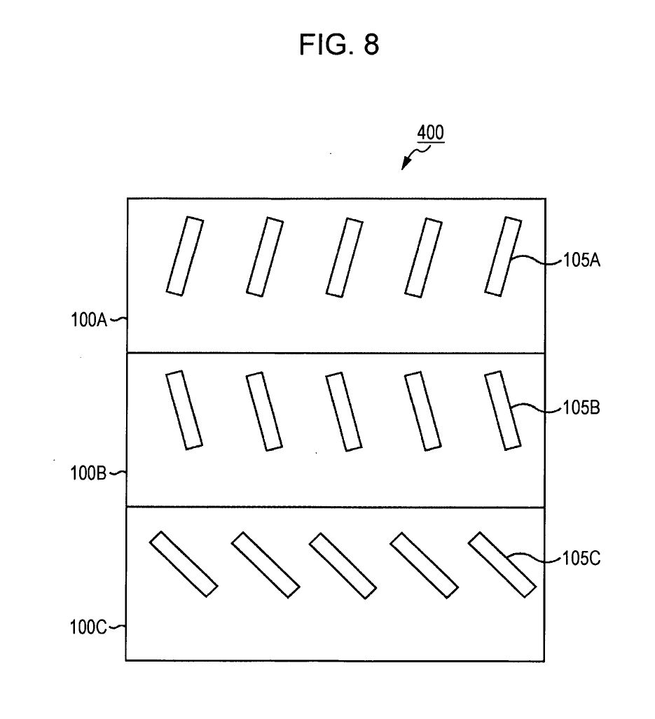

FIG. 8 illustrates yet another configuration example of the bundled leaky coaxial cable according to the embodiment of the present invention. As shown in FIG. 8, in the case of a bundled leaky coaxial cable 400, the slit 105A of the leaky coaxial cable 100A, the slit 105B of the leaky coaxial cable 100B, and the slit 105C of the leaky coaxial cable 100C are angled differently from each other. That is, in the bundled leaky coaxial cable 400, the angle of the slit differs for each leaky coaxial cable.

### 2. Another Embodiment

### Configuration of a Bundled Leaky Waveguide

Although the case where the leaky coaxial cable is used as a MIMO antenna has been described above, a leaky waveguide may be used instead of the leaky coaxial cable.

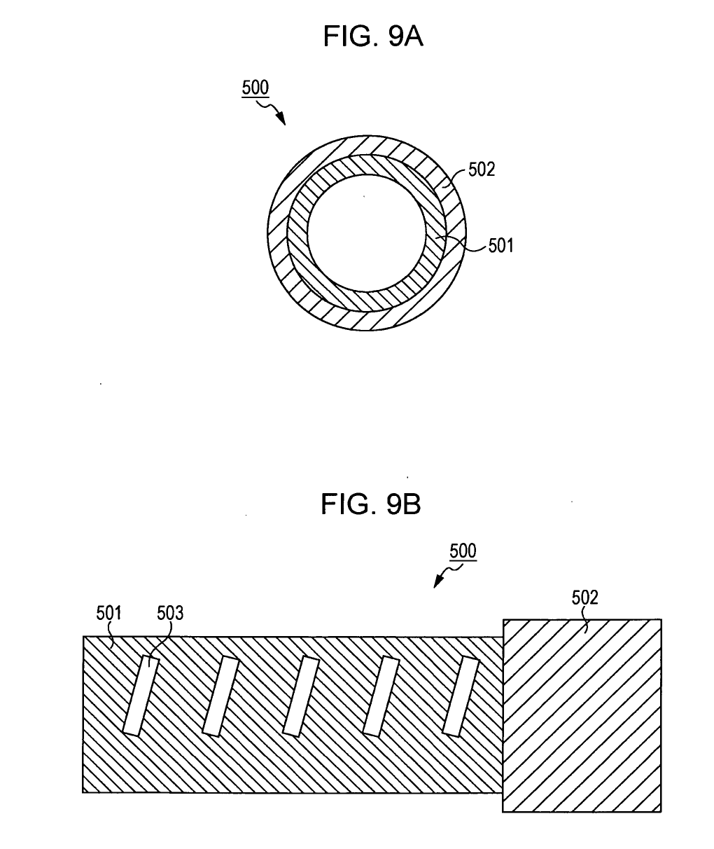

FIGS. 9A and 9B illustrate a configuration example of a leaky waveguide according to another embodiment of the present invention. FIG. 9A shows a sectional surface perpendicular to the longitudinal direction of a leaky waveguide 500. As shown in FIG. 9A, a tubular conductor 501 is covered with a covering material 502 in the leaky waveguide 500.

A waveguide is mainly used in transmission of a millimeter wave, a microwave, or the like. The tubular conductor 501 is a metal tube having a hollow structure and a circular or rectangular sectional surface. An electromagnetic wave propagates inside a tube (in what is called a propagation mode) while forming an electromagnetic field inside the tube according to the shape, dimension, or wavelength (frequency). Since the dielectric is air in the waveguide, it is possible to transmit a large amount of power with a small dielectric loss. Note that a dielectric may be filled inside the tubular conductor 501.

FIG. 9B shows the appearance of the leaky waveguide 500 when seen from a direction where the longitudinal direction is a horizontal direction as in the drawing, when the covering material 502 is removed and the tubular conductor 501 is exposed. As shown in FIG. 9B, the tubular conductor 501 is provided with a slit 503 (small hole) of a predetermined size in a predetermined direction at a predetermined interval.

The leaky waveguide 500 can perform exchange of a radio wave between the inside of the tubular conductor 501 and external space via the slit 503, in a similar manner to the case of the leaky coaxial cable. That is, the leaky waveguide 500 has directionality in a similar manner to the case of the leaky coaxial cable provided with the slit.

Thus, by using the leaky waveguide 500 instead of the leaky coaxial cable 100A, the leaky coaxial cable 100B, and the leaky coaxial cable 100C and bundling multiple leaky waveguides 500 such that the direction of each directionality is different as in the embodiment described first, a MIMO antenna which facilitates an appropriate installation to sufficiently ensure the characteristic of a MIMO antenna can be provided.

### 3. Still Another Embodiment

### Configuration of a Communication System

Next, a communication system which performs a MIMO communication using a bundled leaky transmission line (bundled leaky coaxial cable or bundled leaky waveguide) described above will be described.

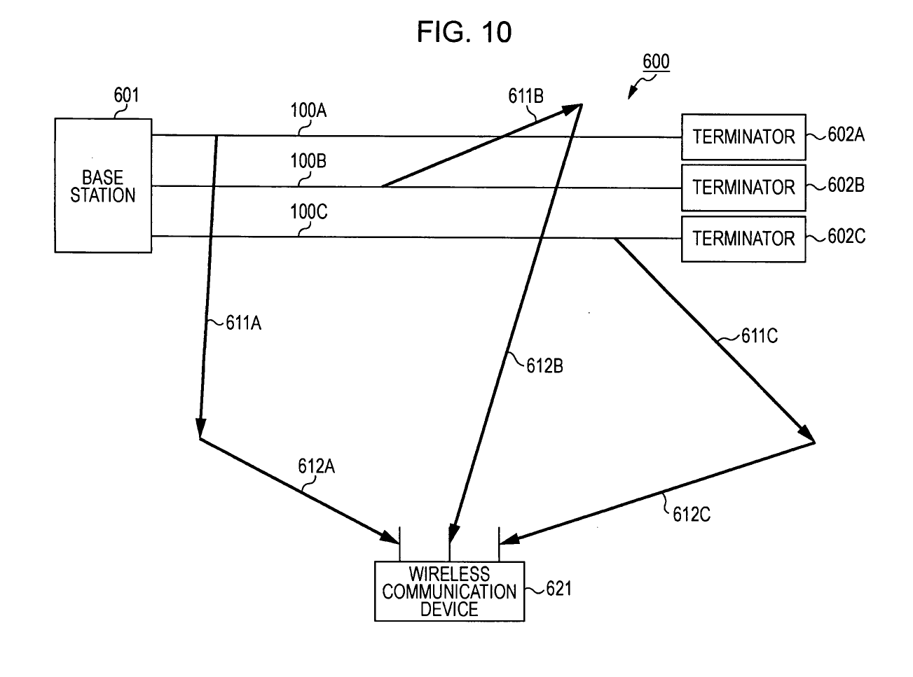

FIG. 10 illustrates a configuration example of a communication system according to still another embodiment of the present invention. As shown in FIG. 10, a communication system 600 according to the still other embodiment of the present invention is a system in which a base station 601 and a wireless communication device 621 perform wireless communication (MIMO communication).

Connected as a MIMO antenna to the base station 601 is a bundled leaky coaxial cable (the bundled leaky coaxial cable 100, the bundled leaky coaxial cable 200, the bundled leaky coaxial cable 300, or the bundled leaky coaxial cable 400) formed of the leaky coaxial cable 100A terminated by a terminator 602A, the leaky coaxial cable 100B terminated by a terminator 602B, and the leaky coaxial cable 100C terminated by a terminator 602C.

As described in the embodiment described first, the leaky coaxial cable 100A, the leaky coaxial cable 100B, and the leaky coaxial cable 100C are bundled such that the characteristic of a MIMO antenna can be obtained sufficiently.

As described in the embodiment described first, the leaky coaxial cable 100A, the leaky coaxial cable 100B, and the leaky coaxial cable 100C are respectively provided with multiple slits (small holes). A part of electrical signals is radiated from the slit as a wireless signal. Also, a wireless signal sent from the wireless communication device 621 is received through the slit, converted to an electrical signal, transmitted inside the leaky coaxial cable, and supplied to the base station 601 as a received signal.

In this manner, the base station 601 performs communication using the leaky coaxial cable 100A, the leaky coaxial cable 100B, and the leaky coaxial cable 100C. Thus, the base station 601 can communicate with the wireless communication device 621 existing within a range along the leaky coaxial cable 100A, the leaky coaxial cable 100B, and the leaky coaxial cable 100C.

Also, by using the bundled leaky transmission line, a spatial range in which the base station 601 is capable of communicating can be limited. Thus, the communication system 600 can be applied not only to a normal wireless communication system but also to a communication system such as, for example, a studio of a broadcast station in which external leakage of a wireless signal is not preferable.

Also, the wireless communication device 621 includes multiple antennas. Therefore, the base station 601 and the wireless communication device 621 can perform MIMO communication. At this time, since the leaky coaxial cable 100A, the leaky coaxial cable 100B, and the leaky coaxial cable 100C are bundled such that the direction of the radio wave directionality is different from each other, the wireless communication device 621 can exchange a wireless signal with the leaky coaxial cable 100A, the leaky coaxial cable 100B, and the leaky coaxial cable 1000 each through a different transmission path.

For example, a wireless signal sent from the leaky coaxial cable 100A is transmitted to the wireless communication device 621 through a path shown by an arrow 611A and an arrow 612A. Also, for example, a wireless signal sent from the leaky coaxial cable 100B is transmitted to the wireless communication device 621 through a path shown by an arrow 611B and an arrow 612B. Further, for example, a wireless signal sent from the leaky coaxial cable 100C is transmitted to the wireless communication device 621 through a path shown by an arrow 611C and an arrow 612C.

That is, the correlation of the leaky coaxial cables is reduced. Thus, the base station 601 and the wireless communication device 621 can perform a stable wireless communication at high speed with the MIMO communication.

Note that the distance between the multiple antennas included in the wireless communication device 621 may be sufficiently smaller than the distance between the leaky coaxial cable 100A, the leaky coaxial cable 100B, and the leaky coaxial cable 100C included in the base station 601.

The wireless communication device 621 may be an information processing device such as, for example, a personal computer (PC), a home-use image processing device (such as a display device, a digital versatile disc (DVD) recorder, or a video cassette recorder), a personal digital assistant (PDA), a home game console, an imaging device, or a home appliance. Also, the wireless communication device 621 may be an information processing device such as a mobile phone, a personal handy-phone system (PHS), a portable music player device, a portable image processing device, or a portable game console.

Also, the base station 601 and the wireless communication device 621 may comply with Institute of Electrical and Electronics Engineers (IEEE) 802.11n.

### [Configuration of the Base Station]

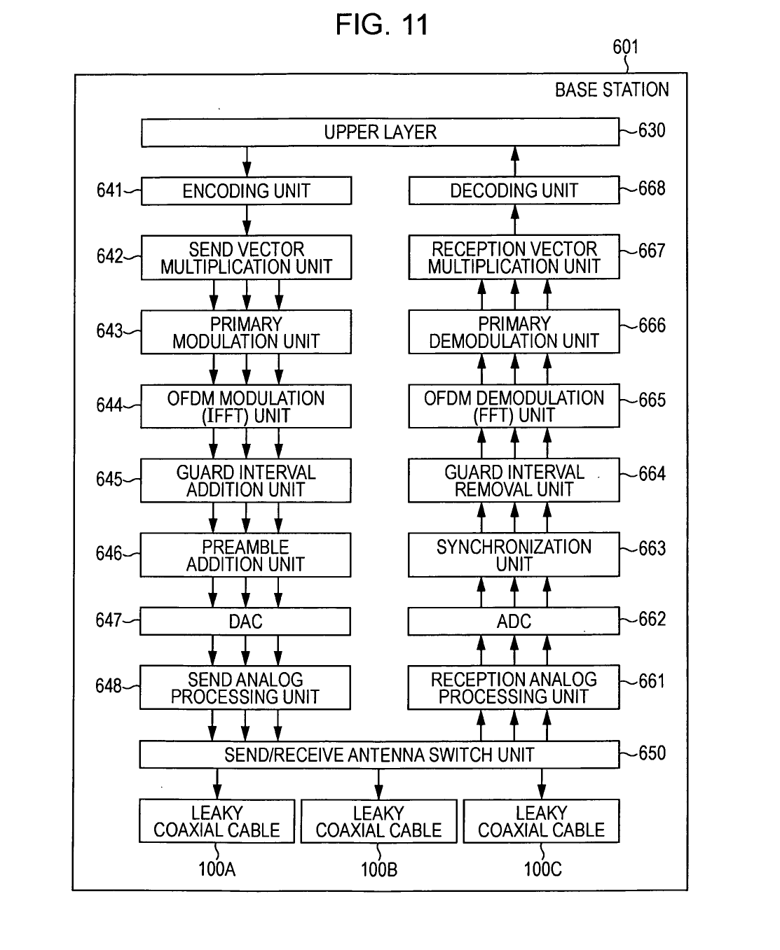

FIG. 11 illustrates a configuration example inside the base station 601.

As shown in FIG. 11, the base station 601 includes, as a configuration for sending, an upper layer 630, an encoding unit 641, a send vector multiplication unit 642, a primary modulation unit 643, an orthogonal frequency division multiplexing (OFDM) modulation unit 644, a guard interval addition unit 645, a preamble addition unit 646, a digital-to-analog converter (DAC) 647, a send analog processing unit 648, a send/receive antenna switch unit 650, the leaky coaxial cable 100A, the leaky coaxial cable 100B, and the leaky coaxial cable 100C.

The encoding unit 641 encodes send data supplied from the upper layer 630. The send vector multiplication unit 642 performs sorting of encoded send data into branches and multiplication of a send vector for a MIMO transmission.

The primary modulation unit 643 divides the send data of each branch to be allocated to each subcarrier and modulates the send data allocated to each subcarrier according to the constellation. Examples of a modulation method include binary phase shift keying (BPSK), quadrature phase shift keying (QPSK), 16-quadrature amplitude modulation (QAM), and 64-QAM.

The OFDM modulation unit 644 generates a time-domain OFDM signal for each branch by an inverse Fourier transform of a modulation signal of each subcarrier. Then, the guard interval addition unit 645 adds a guard interval (for example, 400 ns or 800 ns) to each OFDM symbol configuring the OFDM signal of each branch. Further, the preamble addition unit 646 adds a synchronization preamble at the start of the OFDM signal of each branch to generate a baseband send signal.

The DAC 647 converts the baseband send signal supplied from the preamble addition unit 646 from a digital format to an analog format for each branch. Then, the send analog processing unit 648 converts the baseband send signal converted into the analog format to a high-frequency send signal for each branch.

The send/receive antenna switch unit 650 connects the send analog processing unit 648 with the leaky coaxial cable 100A, the leaky coaxial cable 100B, and the leaky coaxial cable 100C at the time of sending. As a result, the high-frequency send signal of each branch obtained by the send analog processing unit 648 is sent as a wireless signal from the leaky coaxial cable 100A, the leaky coaxial cable 100B, and the leaky coaxial cable 100C.

Also, the base station 601 relating to this embodiment includes, as a configuration for receiving, the upper layer 630, the send/receive antenna switch unit 650, a decoding unit 668, a reception vector multiplication unit 667, a primary demodulation unit 666, an OFDM demodulation unit 665, a guard interval removal unit 664, a synchronization unit 663, an analog-to-digital converter (ADC) 662, a reception analog processing unit 661, the leaky coaxial cable 100A, the leaky coaxial cable 100B, and the leaky coaxial cable 100C.

The send/receive antenna switch unit 650 connects the reception analog processing unit 661 with the leaky coaxial cable 100A, the leaky coaxial cable 100B, and the leaky coaxial cable 100C at the time of reception. As a result, a high-frequency received signal received by the leaky coaxial cable 100A, the leaky coaxial cable 100B, and the leaky coaxial cable 100C is supplied to the reception analog processing unit 661.

The reception analog processing unit 661 converts the high-frequency received signal to a baseband received signal by performing analog processing such as amplification, filtering, or down-conversion on the supplied high-frequency received signal of each branch.

The ADC 662 converts the baseband received signal supplied from the reception analog processing unit 661 from an analog format to a digital format for each branch.

The synchronization unit 663 detects synchronization timing for cutting out a packet frame (OFDM symbol) subsequent to a preamble, based on the synchronization preamble which is added at the start of the received signal.

Then, the guard interval removal unit 664 removes the guard interval from the received signal of each branch to cut out the OFDM symbol according to the synchronization timing detected by the synchronization unit 663.

The OFDM demodulation unit 665 obtains a modulated signal of each subcarrier through a Fourier transform of a time-domain received signal for each OFDM symbol cut out by the guard interval removal unit 664.

The primary demodulation unit 666 demodulates the modulated signal of each subcarrier to obtain a bit string. Then, the reception vector multiplication unit 667 multiplies a demodulated signal of each branch by a reception vector to obtain encoded received data for MIMO reception. The decoding unit 668 decodes the encoded received data to be supplied to the upper layer 630.

As described above, when the base station 601 performs MIMO communication with the wireless communication device 621 via the bundled leaky coaxial cable, the dominant propagation path (radio wave path) between the wireless communication device 621 and the leaky coaxial cable differs significantly for each leaky coaxial cable.

That is, since the correlation of the propagation paths decreases, improvement can be expected of the bundled leaky coaxial cable (the leaky coaxial cable 100A, the leaky coaxial cable 100B, and the leaky coaxial cable 100C) provided to the base station 601 in the characteristic (high speed and stability of communication) of a MIMO antenna.

Since the leaky coaxial cable 100A, the leaky coaxial cable 100B, and the leaky coaxial cable 100C are bundled together, an installation worker can install the leaky coaxial cable 100A, the leaky coaxial cable 100B, and the leaky coaxial cable 100C easily and appropriately without expertise.

Also, not only can the installation cost be reduced, but also the appearance of the space can be prevented from being impaired by the installation of the antenna.

Note that the leaky waveguide in the embodiment described second may be applied instead of the leaky coaxial cable.

In this specification, a system refers to an entire apparatus configured of multiple devices.

Also, a configuration described above as one device (or processing unit) may be configured as multiple devices (or processing units). On the other hand, a configuration described above as multiple devices (or processing units) may be configured together as one device (or processing unit). Also, a configuration other than that described above obviously may be added to the configuration of each device (or each processing unit). Further, a part of a configuration of a device (or processing unit) may be included in a configuration of another device (or another processing unit), as long as the configuration or operation of a system as a whole is substantially the same.

The present application contains subject matter related to that disclosed in Japanese Priority Patent Application JP 2010-066632 filed in the Japan Patent Office on Mar. 23, 2010, the entire contents of which are hereby incorporated by reference.

Embodiments of the present invention are not limited to the embodiments described above, and various modifications are possible within the scope of the embodiment of the present invention.

What is claimed is:

1. A bundled leaky transmission line comprising:
a transmission line inside which a signal is transmitted; wherein
multiple leaky transmission lines which exchange a radio wave mainly via a slit provided on an outer circumference of the transmission line are bundled; and
the leaky transmission lines are bundled together such that the slit which is provided to each of the leaky transmission lines and which gives radio wave directionality to the leaky transmission line is directed in a direction different from each other.

2. The bundled leaky transmission line according to claim 1, wherein the leaky transmission lines are bundled together with a predetermined supporting material so as to maintain a distance of half a wavelength of the exchanged radio wave or greater.

3. The bundled leaky transmission line according to claim 1, wherein the slit of each of the leaky transmission lines is provided at an angle different from each other so that a radio wave of which a direction of a polarization plane is different from each other is exchanged.

4. The bundled leaky transmission line according to claim 1, wherein the leaky transmission line is a leaky coaxial cable which includes a center conductor as the transmission line and an external conductor formed on an outer circumference of the center conductor with an insulator in between and including the slit.

5. The bundled leaky transmission line according to claim 1, wherein the leaky transmission line is a leaky waveguide which includes, as the transmission line, a tubular conductor provided with the slit and having a hollow structure.

6. The bundled leaky transmission line according to claim 1, wherein each of the leaky transmission lines functions as a multiple-input multiple-output (MIMO) antenna which simultaneously exchanges a signal different from each other.

7. A communication device comprising:
a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna; and
communication means for exchanging a signal via the bundled leaky transmission line to perform MIMO communication with another device.

8. A communication system in which a first communication device and a second communication device perform communication with each other, wherein:
the first communication device includes
a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna, and
first communication means for exchanging a signal via the bundled leaky transmission line to perform MIMO communication with the second communication device; and
the second communication device includes second communication means for performing the MIMO communication with the first communication device.

9. A communication device comprising:
a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna; and
a communication unit configured to exchange a signal via the bundled leaky transmission line to perform MIMO communication with another device.

10. A communication system in which a first communication device and a second communication device perform communication with each other, wherein:
the first communication device includes
a bundled leaky transmission line including a transmission line inside which a signal is transmitted, wherein multiple leaky transmission lines which exchange a radio wave mainly via a slit provided on an outer circumference of the transmission line are bundled, the leaky transmission lines are bundled together such that the slit which is provided to each of the leaky transmission lines and which gives radio wave directionality to the leaky transmission line is directed in a direction different from each other, and the bundled leaky transmission line functions as a multiple-input multiple-output (MIMO) antenna, and
a first communication unit configured to exchange a signal via the bundled leaky transmission line to perform MIMO communication with the second communication device; and
the second communication device includes a second communication unit configured to perform the MIMO communication with the first communication device.
